(19) United States
(12) Patent Application Publication
(10) Pub. No.: US 2004/0170159 A1
(43) Pub. Date: Sep. 2, 2004

(54) Digital audio and/or video streaming system

(76) Inventors: Myong Gi Kim, Long Grove, IL (US); Arthur Yerkes, Chicago, IL (US)

Correspondence Address: WELSH & KATZ, LTD, 120 S RIVERSIDE PLAZA, 22ND FLOOR, CHICAGO, IL, 60606, US

(21) Appl. No.: 10/376,866

(22) Filed: Feb. 28, 2003

(51) Int. Cl. H04L 12/66

(52) U.S. Cl. 370/352; 370/259

(57) ABSTRACT

A digital multimedia streaming system has an encoder having an input port that receives input digital multimedia (video and audio) signals and an output port that outputs encoded digital multimedia signals. The encoded digital multimedia signals are encoded from the input digital multimedia signals. The system also includes a player having an input port that receives the encoded digital multimedia signals and an output port that outputs an output digital multimedia signal. The output digital multimedia signals are decoded from the encoded digital multimedia signals. Latency between the input digital multimedia signals and the output digital multimedia signals are less than one second. The system also has a server having at least one input port, which receives the encoded digital multimedia signals from the encoder, operatively connected to the output port of the encoder, and at least one output port that outputs the encoded digital multimedia signals. A method for multimedia streaming is also disclosed.

### BACKGROUND OF THE INVENTION

The field of the invention relates to digital streaming systems, and in particular, to multimedia streaming and the near-instantaneous delivery and playback of digitally encoded audio and video. Internet broadcasting or web casting allows many people to listen to radio stations or to view news programs over the internet. However, internet broadcasting or web casting has an average latency of 5-20 seconds. That is, from the time the internet radio station starts the music or talk radio program, listeners will actually hear it 5-20 seconds later. The source of this latency comes from, for example, encoding, internet transport (distribution), and decoding.

While this kind of latency may be acceptable for some applications (e.g. listening to music, talk shows and any pre-recorded program may be acceptable), there are time-critical applications for which a 5-20 second delay is unacceptable. For example, real-time market updates, emergency broadcasts (fire, natural or manmade disasters), military, police or 911 dispatches may not be able to tolerate such a delay.

One obstacle to internet broadcasting is the high cost of the encoding station, both for hardware and software. The complexity associated with setting up the encoding station, as well as the required maintenance makes it even more difficult to establish and operate such an encoding station. Another obstacle is the lack of a standard in audio, as well as, video players. Presently, there are three major media players, Microsoft's Windows Media™, RealNetworks's Real One™ and Apple's QuickTime Media Player™, that can play back digital multimedia streams. Each of these players requires different ways of broadcasting over the internet. The variety of network protocols, routing methods and security rules governing the usage of the internet also make internet broadcasting difficult.

One method of broadcasting over the internet is termed streaming. Microsoft®, RealNetworks®, and Apple® Computer are the three largest companies offering streaming products. However, streams from each of their systems are generally incompatible with one another. Streams encoded by Microsoft's Windows Media™ Server only work with Windows Media Player or Real One player, those encoded by RealNetworks' Real Server™ can only be played by RealPlayer™, while those encoded by Apple's QuickTime only work with the QuickTime Media Player™ or Real One player.

At nearly the same time the Microsoft, RealNetworks and Apple Computer developed their proprietary streaming systems, the Motion Pictures Experts Group (MPEG), a trade organization concerned with setting broadcast standards for the motion picture industry, released the MPEG-1 standard for encoding and compressing digital audio and video. A subset of this specification, MPEG-1 layer 3 audio (commonly referred to as MP3), quickly became the most popular compressed digital audio format because of its superior compression ratios and audio fidelity. Further contributing to the popularity of the MP3 format was the widespread availability of inexpensive (and in many cases, free) authoring and playback tools made possible by the presence of an open, published standard. Driven by overwhelming public support for the MP3 format, many such media players, including RealPlayer, Windows Media Player, and QuickTime, quickly added support for the MP3 standard.

Seizing on the popularity of the MP3 audio format, On-Demand Technologies™ (“ODT”) developed the AudioEdge™ server, which simultaneously serves a single MP3 audio stream to all major players. Prior to AudioEdge™, broadcasters wishing to stream to their widest possible audience were required to encode and serve streams using multiple proprietary platforms. With AudioEdge™, one MP3 encoder and one serving platform reach all popular players. In this manner, AudioEdge™ saves bandwidth, hardware, and maintenance costs. Additionally, because AudioEdge™ supports Windows Media (the most popular proprietary streaming media format) and MP3 (the most popular standard based streaming media format) streams, the AudioEdge™ system eliminates the risk of technology lock-in, which is associated with many proprietary platforms.

Multimedia streaming is defined as the real-time delivery and playback of digitally encoded audio and/or video. The advantages of streaming compared to alternative methods of distributing multimedia content over the internet are widely documented, among the most important of which is the ability for immediate playback instead of waiting for the, complete multimedia file to be downloaded.

Two types of streaming are common today on the internet: on-demand and live. ODT AudioEdge™ delivers both live and on-demand (archived file) streams encoded in MP3 or Windows Media (WMA) format, and can be played using the major media players. Additionally, AudioEdge™ is capable of delivering both archived Apple QuickTime and RealNetworks encoded media files on-demand.

On-demand streaming delivers a prerecorded (e.g., an archived) multimedia file for playback by a single user upon request. For on-demand streaming, an archived file must be present for each user to select and view. An example of on-demand streaming would be a television station that saves each news broadcast into an archived file and makes this archived file available for streaming at a later time. Interested users would then be able to listen to and/or view this archived broadcast when it is so desired.

Live streaming involves the distribution of digitized multimedia information by one or more users as it occurs in real-time. In the above example, the same news station could augment its prerecorded archived content with live streaming, thus offering its audience the ability to watch live news broadcasts as they occur.

Live streaming involves four processes: (1) encoding, (2) splitting, (3) serving, and (4) decoding/playback. For successful live streaming, all processes must occur in real-time. Encoding involves turning the live broadcast signal into compressed digital data suitable for streaming. Splitting, an optional step, involves reproducing the original source stream for distribution to servers or other splitters. The splitting or reflecting process is typically used during the live streaming of internet broadcasts (webcasts) to many users when scalability is important.

Serving refers to the delivery of a live stream to users who wish to receive it. Often, serving and splitting functions can occur simultaneously from a single serving device. Last, decoding is the process of decompressing the encoded stream so that it can be heard and/or viewed by an end user. The decoding and playback process is typically handled by player software such as RealNetwork's Real One Player, Microsoft's Windows Media Player, or Apple's QuickTime player. All further uses of the term “streaming” refer to live streaming over the internet, and further uses of the term “server” refer to a device capable of serving and splitting live streams.

As noted earlier, three major software players are available, however, they are not compatible with each other. In other words, a proprietary RealNetworks-encoded audio stream can only be served by a RealNetworks server and played with the RealNetworks Real One Player. RealNetwork claims that their new Real One player, made available in late 2002, can play back Windows Media streams as well as Apple QuickTime's MPEG-4 format. However, in all practicality, the broadcaster would have to choose one of the three proprietary streaming formats, knowing that certain listeners will be excluded from hearing and/or viewing the stream, or simultaneously encode and stream in all three formats.

Unfortunately, existing streaming audio and/or video technologies, although termed live, still exhibit a time delay from when an audio or video signal, is encoded to when the encoded signal is decoded to produce an audio or video output signal. For person-to-person conversation, for example, this delay of as much as 20 seconds is simply unacceptable.

In general, the internet broadcasting of video and audio introduces an average latency of 5-20 seconds. That is, from the time live video and audio frames are being captured, to the time viewers can actually hear and view the frames, is about 5-20 seconds. The sources of this latency for audio and video are similar, and are generally a result of encoding (e.g., video/audio capture and compression of data), delivery (e.g., splitting, serving and transport over IP), and decoding (e.g., buffering, data decompression and play back).

Thus, there exists a need for an improved system for sending and receiving audio and video over a network, such as the internet, with minimal delay. Such a minimal delay may be one that is not perceptible to a user. Such minimal delay may also be referred to as “real-time”, “no delay” or “zero delay”.

### BRIEF SUMMARY OF THE INVENTION

To overcome the obstacles of known streaming systems, there is provided a digital streaming system and method that includes an encoder and a player. The encoder has an input port that receives at least one of input digital video signals and input digital audio signals and an output port that outputs an encoded digital multimedia (video and audio) signal. The encoded digital multimedia signal is encoded from the input digital video and/or audio signals. The player has an input port that receives the encoded digital video and/or audio signal and an output port that outputs digital video and/or audio signals. The output digital signals are decoded from the encoded digital signal. A latency between the input digital signals of the encoder and output digital signals of the player is less than one second.

### BRIEF DESCRIPTION OF THE SEVERAL VIEWS OF THE DRAWINGS

The features of the present invention, which are believed to be novel, are set forth with particularity in the appended claims. The invention may best be understood by reference to the following description taken in conjunction with the accompanying drawings. In the several figures like reference numerals identify like elements.

FIG. 1 is a block diagram of an example of a digital audio streaming system;

FIG. 2 is a block diagram of another example of a digital audio streaming system with a different configuration;

FIG. 3 is a detailed block diagram of a digital multimedia streaming system;

FIG. 4 is a block diagram of another example of a digital multimedia streaming system;

FIG. 5 is a block diagram of another example of a digital multimedia streaming system;

FIG. 6 is a block diagram of another example of a digital multimedia streaming system;

FIG. 7 is a block diagram of an example of a bi-directional (multipoint 2-way) digital multimedia streaming system;

FIG. 8 is a flowchart depicting one embodiment of encoder data flow for SpeedCast Audio system (low-latency audio only system);

FIG. 9 is a flowchart depicting one embodiment of server data flow for SpeedCast Audio system;

FIG. 10 is a flowchart depicting one embodiment of player data flow for SpeedCast Audio system;

FIG. 11 is a flowchart depicting one embodiment of encoder data flow for SpeedCast Video system (low latency audio and video system);

FIG. 12 is a flowchart depicting one embodiment of server data flow for SpeedCast Video system; and

FIG. 13 is a flowchart depicting one embodiment of player data flow for SpeedCast Video system.

### DETAILED DESCRIPTION OF THE INVENTION

While the present invention is susceptible of embodiments in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

It should be further understood that the title of this section of this specification, namely, “Detailed Description Of The Invention”, relates to a requirement of the United States Patent Office, and does not imply, nor should be inferred to limit the subject matter disclosed herein.

The internet network, as used herein, includes the world wide web (web) and other systems for storing and retrieving information using the internet. To view a web site, a user typically points to an electronic web address, referred to as a uniform resource locator (URL), associated with the web site.

At least one embodiment of the system provides a method by which thousands of users can listen to an audio stream simultaneously and economically with very little delay. The typical latency may be 500 ms within the pubic internet. Also, by connecting the encoding station with a generic telephone line, an audio stream may be broadcast from any wired or wireless phones. Other embodiments may not require special hardware or media players. Any internet ready Windows-based computer with a standard sound card and speaker allows users to listen to the broadcasted audio stream.

The present audio system provides faster voice broadcasting over IP than prior art systems using at least an encoder, a server and a player. Various reasons for this improvement have been observed.

For example, one reason is auto-negotiation of the internet transport layer. Depending on the network configuration between the server and player, the audio broadcast can be accomplished via one of the 3 methods: multicast, unicast user datagram protocol (UDP), and tunneled real-time transport protocol (RTP). If the network configuration for the player (client) is capable of accepting multicast packets, the server will transmit multicast packets. If not, unicast UDP or tunneled RTP transport methods will be used. Multicasting is a preferred method over unicast UDP or tunneled RTP because it uses less bandwidth than unicast, and will have less latency than tunneled RTP. Regardless of the network protocols chosen, each audio packet is time-stamped in every 20 ms frame. This time-stamp is used later to reconstruct the packets.

Next, are client and server buffering techniques which typically maintain a dynamically sized buffer that responds to network and central processing unit (CPU) conditions. In general, these buffers are kept as small as possible, because this reduces the time between the voice sample being encoded, and the transmitted voice sample being decoded. Each voice sample may be transmitted every 20 ms, and the system may hold a minimum of one sample and a maximum of 50 samples. The current setting is designed for the worst case latency of one second. Usually this dynamic buffer will hold no more than 10 samples.

The third reason is the choice of audio encoding. The audio system may be tuned to operate at peak efficiency when delivering a broadcast of the human voice. Parameters taken into account when choosing the audio encoding mechanism for the system may include, for example, high compression ratio for encoding while preserving audio quality; data stream ability to be multiplexed; avoidance of forward or backward temporal dependency in encoding (e.g., that is, the data packets produced must be represented as independent blocks which represent a certain slice of time of the original recording delta, and most of the waveform represented by that block may be recovered without reference to adjacent packets, some of which may be lost); and encoding and decoding need not require the top of the line CPUs for their respective computers. Preferably, however, the encoding station is at least a 1.5 GHz Intel CPU or the equivalent, and the decoding station is at least a 500 MHz Intel CPU to run the player.

For clear voice quality the global system for mobile communications (GSM) codec was chosen for the audio system designed for human voice. This codec filters out background noise from the surrounding environment. Since the psycho-acoustic model is specially tuned for human voice processing, the types of errors in the audio will be limited to errors that sound more natural to human speakers (e.g., switching the “F” sound with the “TH” sound). The usual static or “garbled robot-like voice” typical in direct analog (non-psycho-acoustic) or digital reproductions are unlikely to happen.

For low bandwidth per stream, each audio stream is set for 13 kbits/sec (kbps). Many streaming radio stations use between 24 and 128 kbps. The tradeoff is that generic streaming radio may carry a wide variety of audio types (e.g., rock, jazz, classic and voice) while the audio system is specifically tuned to human voice reproduction. Grouping GSM packets into UDP packets further saves bandwidth.

For secure communication, log-in and data encryption and user authentication may be implemented in the speech broadcasting system.

User and data encryption can be performed using the industry-standard SSL (Secure Socket Layer). The algorithm used may be changed on a per-socket basis, and by the “amount” of encryption (number of bits used in keys). Using SSL also allows the system to interface with a common web browser, making different types of media applications easy. For example, the same server may serve both real-time live streaming media and pre-recorded (archived or on-demand) media files. Their usage may be accurately accounted for by a user authentication system. Accounting coupled with authentication gives the operator of the system an easy way to facilitate billing.

User authentication can be layered on top of the encryption layer and is independent of the encryption layer. This form of authentication performs secure authentication, without exposing the system to potential forgery or circumvention. This permits the use of any method to store user names and passwords (e.g., UNIX password file, htaccess database, extensible markup language (XML) document, traditional database and flat file).

The client software can run on Windows 2000 and XP as MS ActiveX controls, compatible with MS Internet Explorer (IE). The server supports multicast for most efficient bandwidth utilization within intranets. It also supports unicast for most commonly used transport over current IPV4 networks. For those users that are protected by tight firewalls, tunneled hyper text transfer protocol (HTTP) transport may be used.

The system is easy to use for those listening to audio streams. All that is required is a web browser, such as Internet Explorer, that can instantiate ActiveX controls. Once the user visits the appropriate web site, the program is downloaded, installs itself, fetches its configuration files, and attempts to start the most efficient stream type. If the player detects problem(s), it tries an alternative transport type and/or a different codec. It does so in the order of preference until a stream with desirable transport (e.g. multicast, unicast and tunneled HTTP) is established at an appropriate bandwidth. As such, the end user does not have to configure the player to circumvent any firewall restrictions that may be in place.

In one embodiment of the system, the audio encoding station contains elements necessary for listening to many audio broadcasts. It can also have the following software: Linux RedHat 7.x; Apache web server; GSM encoder; auto-answering modem software; audio streaming server; and Streaming Server Administrator (SSA)—Java program used to set up and administer audio system. In this embodiment, the audio encoding station can be bundled with an audio streaming server. This server can be, for example, a Linux-based internet “appliance” equipped with GSM encoder, voice capture modem (or wireless microphone) and low latency audio. This appliance is a 1U high rack-mountable server with the following specifications: 1 GHz Pentium processor; 256 MB memory; 20 GB hard drive; Red Hat Linux 7.1 operating system; Dual100 Base-T Ethernet NIC; high quality Data/Fax/Voice internal modem; multimedia sound card; and optional wireless microphone and receiving station.

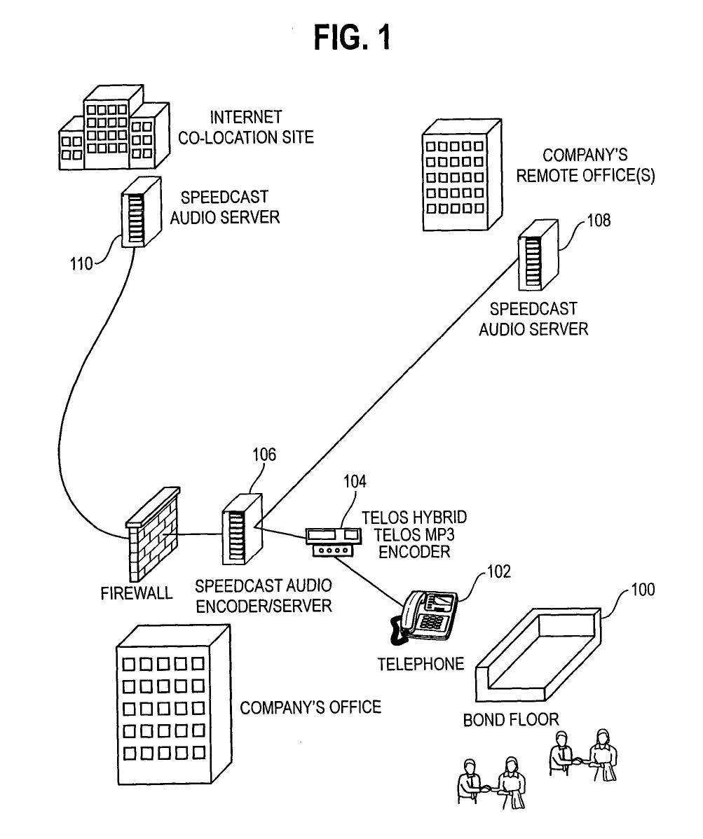

Referring now to FIG. 1, there is shown Scenario “A” in which the broadcast origination point may be the floor of a major securities exchange 100. To initiate the broadcast, the individual providing the audio content dials the telephone number corresponding to a dedicated phone line 102 connected to the system. A modem 106 (with voice capture) answers the call and passes the signal to the encoder 104. The encoder 104, in turn, passes the digitally encoded signal to the server 106 for the distribution of the signal via a streaming server 108 within the local area network (LAN), e.g., an intranet, or via a streaming server 110 over the internet. A player residing in any desktop PC connected to one of the streaming servers, for example, will decode the digital signal and play back the voice data.

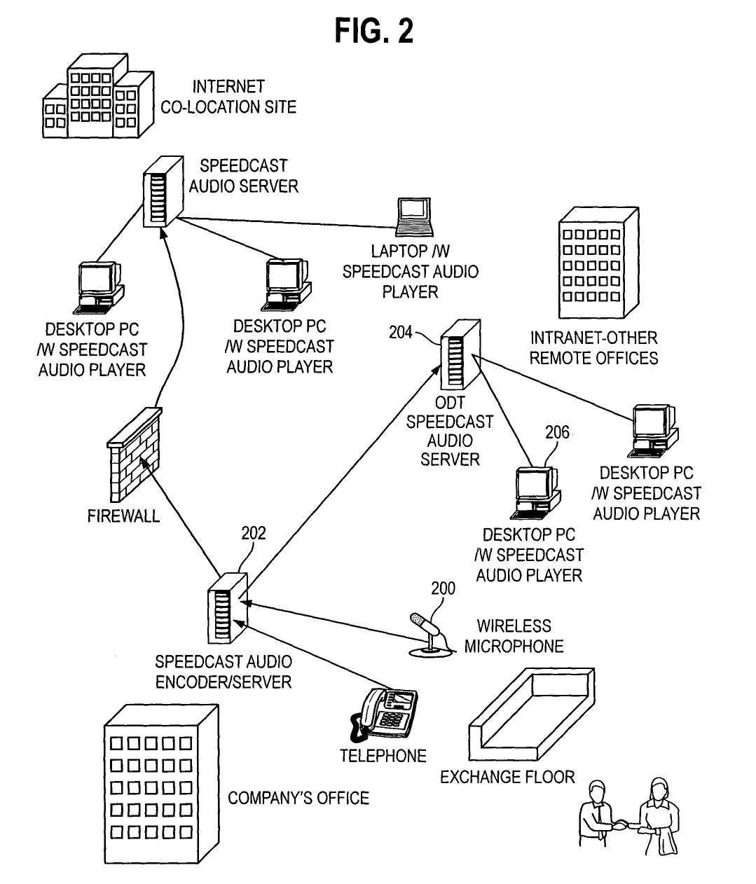

FIG. 2 illustrates Scenario “B” in which the broadcaster (“squawker”) speaks into a wireless microphone 200 linked directly to the server 202 equipped with a wireless station. Encoder/server 202 captures the voice, encodes the audio signals and transmits them to server 204 for distribution. A player residing in any desktop PC, for example PC 206, decodes the digital signal and plays back the voice data. These system concepts can also be applied to video and audio for multimedia systems.

An exemplary embodiment of a multimedia system includes up to about eight (8) logical software subsystems: encoder, slide presenter, whiteboard (collaboration tools), IRC server, reflector, conference server or multipoint control unit (MCU) and player. An optional conference gateway can handle packet-level translation of H.323 and session initiation protocol (SIP) based conferencing to make the SpeedCast Video system interoperable with these types of systems.

The encoding station is responsible for encoding the video/audio channels, packetizing audio/video channels, and transmitting the packetized streams to a reflector. The slide presenter provides a series of static images, such as joint photographic exerts group (JPEG) or portable network graphic (PNG) format, that are generated using MS PowerPoint. This is part of the logically independent data channel. Therefore, other data channels such as a spreadsheet, Word file and the like can be channeled through accordingly. Internet Relay Chat (IRC) handles standard chat functions. It consists of an IRC server residing on the conference server or reflectors and IRC client residing on every desktop computer where a player runs.

The reflector distributes streams that are received (video, audio, data, chat session and control channels) within its video conferencing group. Depending on the availability of multicasting network, the reflector may either multicast or unicast the received streams. Each reflector acts as a proxy server for its video conferencing subgroup. The player decodes and plays-back audio and video stream(s). It also processes and displays IRC messages (send and receive windows), PowerPoint images, whiteboard image(s), and the like.

The conference server receives all the encoded audio/video streams, reconstructs them to a single frame, and transmits them to all the players within the video conferencing group via the reflectors. The conference server also receives and distributes PowerPoint and whiteboard images. In addition, it handles all the conference management, session management, user administration (authentication, joining, leaving of video conferencing) and collaboration tasks.

These software subsystems may be hosted in four (4) classes of computers (preferably Intel PCs): a first player station, which may be a Windows PC running player, IRC client, presenter client and whiteboard client applications; a second encoding station for running the encoder, the presenter server and the whiteboard server; a reflector or server, which may be a Linux-based multimedia streaming server housing a reflector which acts as a transmission control protocol (TCP) and RTP splitter and a proxy server, as well as a multicast repeater, and which may also host an IRC server; and an optional video conferencing server, which may be a Linux-based server housing conference management software and an IRC server, other H.323 or SIP enabled devices being connected via a conference gateway.

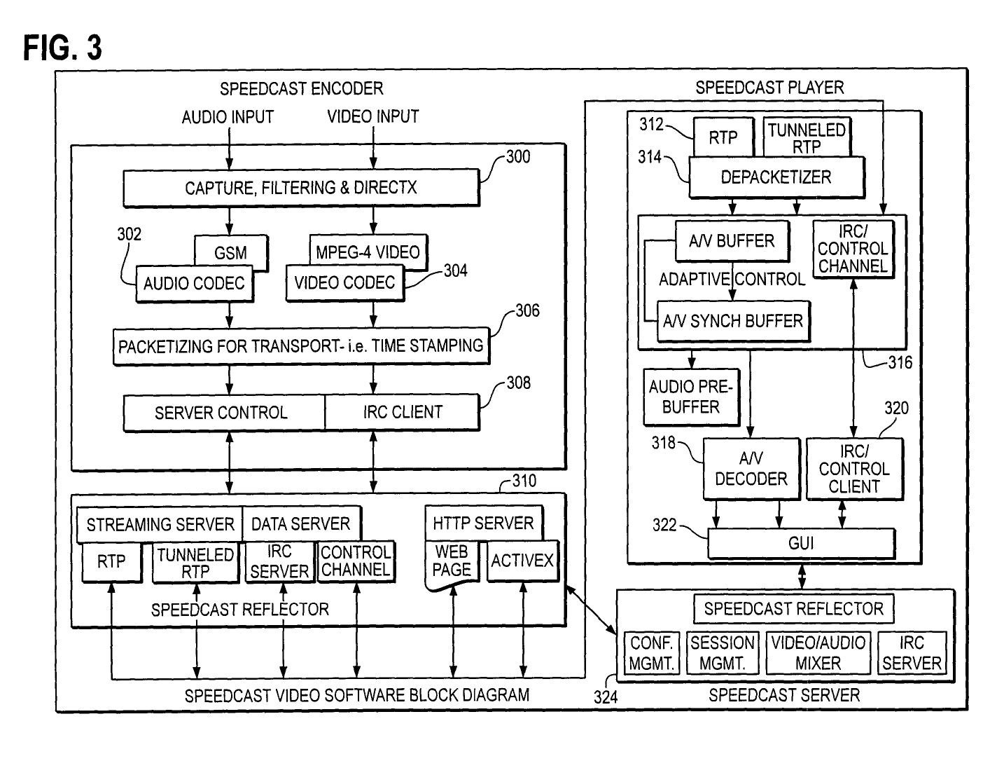

FIG. 3 is a logical block diagram of the SpeedCast Video system. Currently, the SpeedCast Encoder and Speed Cast Player are designed for MS Windows. The SpeedCast conference server, IRC serve and reflector are designed for Linux.

A capture, filtering, and DirectX module 300 has audio and video inputs, and has outputs to an audio codec 302 and a video codec 304. A packetizing module 306 is operatively connected to the audio codec 302 and the video codec 304. Server control 308 and IRC client 310 interface the packetizing module 306 to a server 310.

The server 310 communicates with a client 312. The client 312 has a depacketizing module 314, an adaptive control module 316, an audio/video decoder 318, and an IRC control client 320. An interface module 322 operatively connects the client 312 to a reflector 324.

Depending on the specific application, the system can be configured in many different ways. The following are exemplary configurations for different applications.

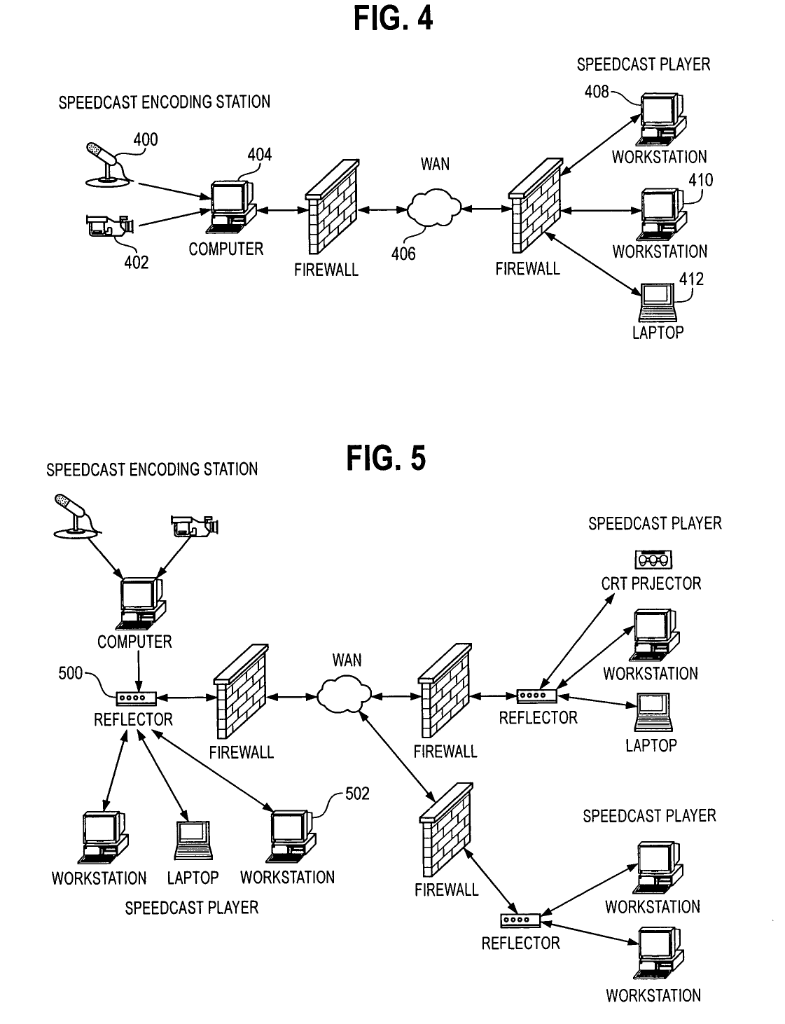

FIG. 4 illustrates Case 1, which is an example of a corporate communications system for a small group. One server computer is used to run all the server applications. Audio component 400 and video component 402 are operatively connected to the server computer 404. The server computer 404 communicates via a wide area network 406 with players, work stations 408, 410, and laptop 412.

FIG. 5 illustrates Case 2 which is an example of a corporate communications or E-learning system for a large group of users. Each office may have a reflector 500, which can serve up to 600 unicast (TCP or RTP) clients (for example workstation 502) using up to 300 Kbps. For multicast networking, each receiving reflector may receive one unicast stream and route it as multicast packets within its multicast-enabled LAN.

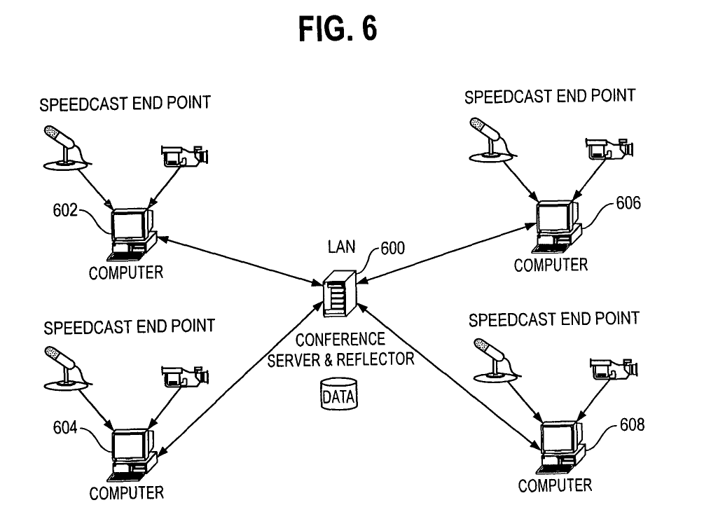

Case 3 is illustrated in FIG. 6 and is exemplary of a small-scale video conferencing system within a LAN to, for example, provide bi-directional exchange of real-time media data between computers via the LAN. A SpeedCast reflector and conference server 600 may reside in a single Intel box. The reflector and conference server 600 interconnects computers 602, 604, 606 and 608. Those skilled in the art will recognize that the same principles can be used to provide bi-directional exchange of real-time media data between computers via the internet.

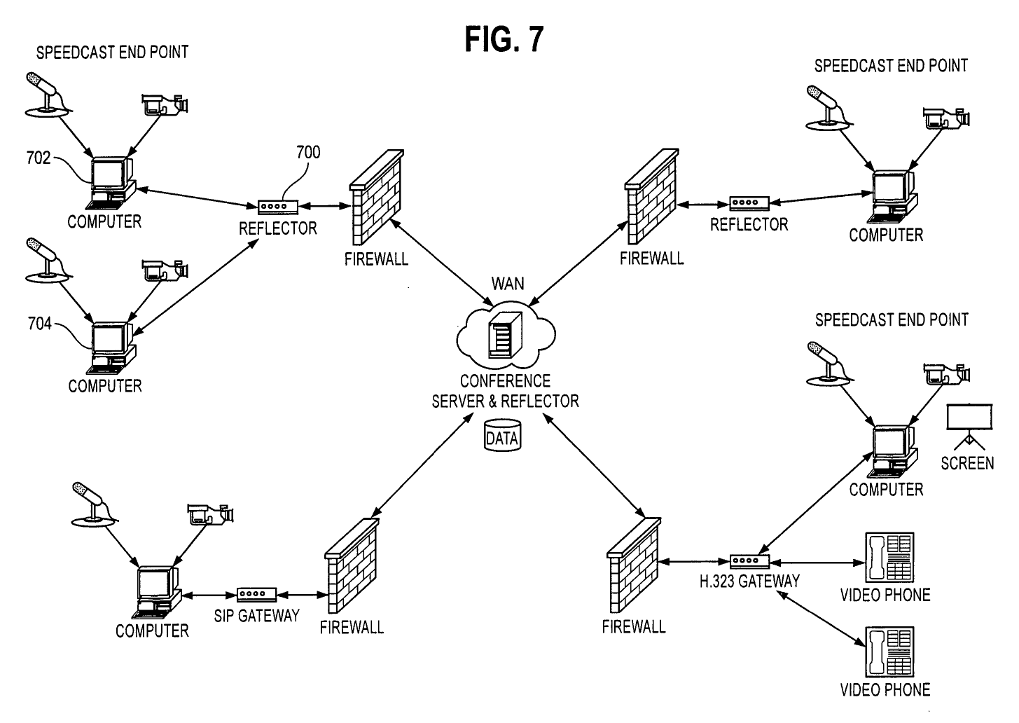

FIG. 7 illustrates Case 4, which is exemplary of a corporate video conferencing system with several remote offices participating. Each office may have a reflector (700, for example) to distribute incoming and outgoing video conferencing streams (to computers 702, 704, for example). The SpeedCast player, implemented as ActiveX controls, is designed to run on a Windows PC requiring only a browser (currently IE 6.0 or higher). It requires users to login to the conference server before users can participate in video conferencing. The SpeedCast user interface can include live video window(s), IRC session window, slide presenter window and whiteboard window. The following examples demonstrate typical usage.

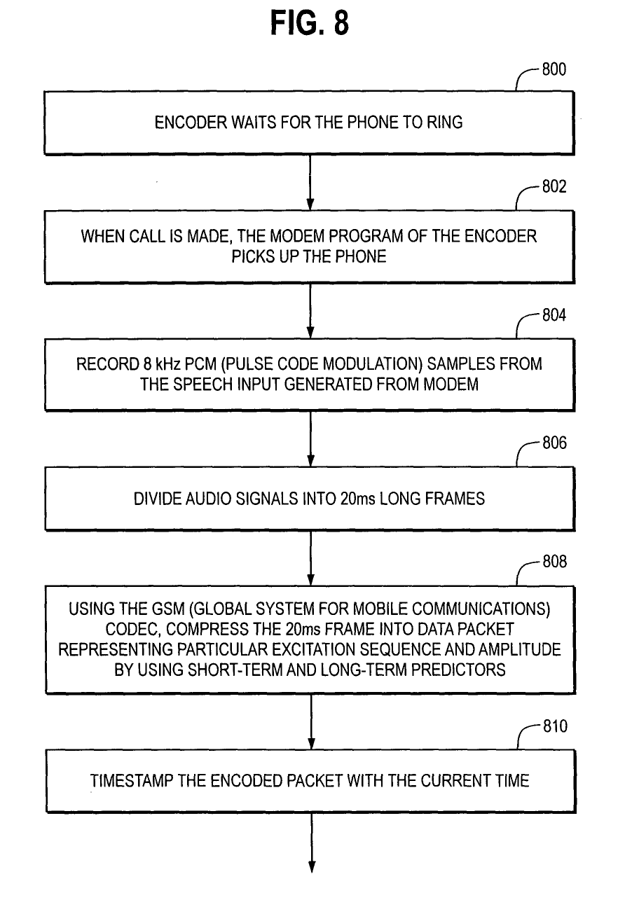

FIG. 8 depicts a system and method for SpeedCast Audio Encoder data flow. The following steps are shown: encoder waits for the phone to ring (step 800); when a call is made, the modem software of the encoder picks up the phone (step 802); record 8 kHz PCM (Pulse Code Modulation) samples from the speech input generated from modem (step 804); divide audio signals into 20 ms long frames (step 806); using the GSM codec, compress the 20 ms frame into data packets representing particular excitation sequence and amplitude by using short-term and long-term predictors (step 808); and time-stamp the encoded packet with the current time (step 810).

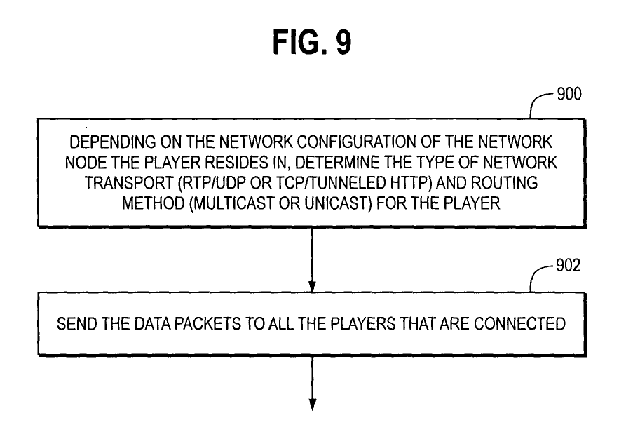

FIG. 9 illustrates a system and method for SpeedCast Audio Server data flow. The following steps are shown: depending on the network configuration of the network node the player resides in, determine the type of network transport (RTP/UDP or TCP/Tunneled HTTP) and routing method (multicast or unicast) for the player (step 900); and send the data packets to all the players that are connected (step 902).

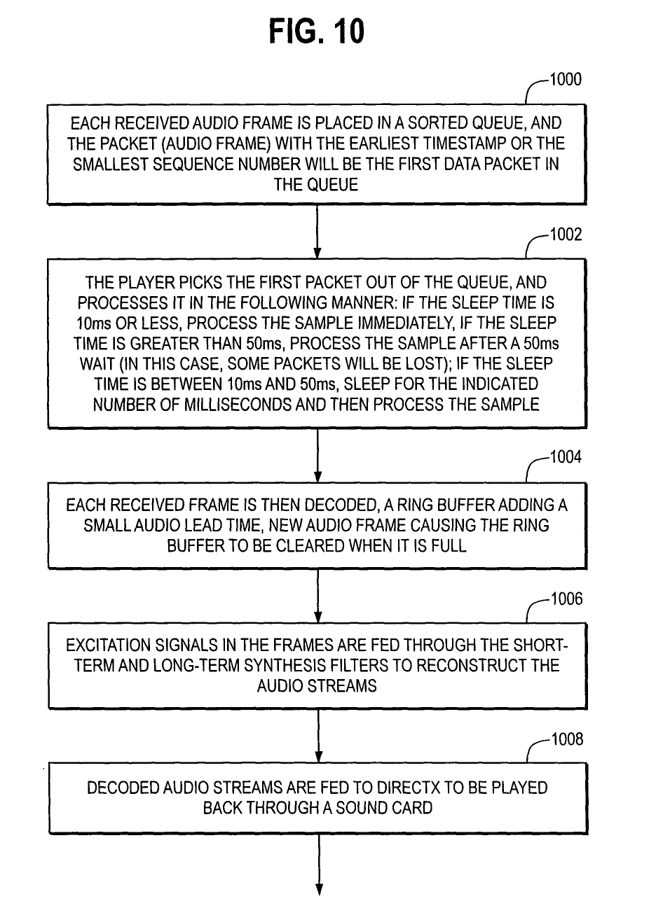

FIG. 10 illustrates a system and method for SpeedCast Audio Player data flow. The following steps are shown: each received audio frame is placed in a sorted queue, and the packet (audio frame) with the earliest time-stamp or the smallest sequence number is the first data packet in the queue (step 1000); the player picks the first packet out of the queue, and processes it in the following manner: if the sleep time is 10 ms or less, process the sample immediately, if the sleep time is greater than 50 ms, process the sample after a 50 ms wait (in this case, some packets will be lost); if the sleep time is between 10 ms and 50 ms, sleep for the indicated number of milliseconds and then process the sample (step 1002); each received frame is then decoded, a ring buffer adding a small audio lead time, new audio frame causing the ring buffer to be cleared when it is full (step 1004); excitation signals in the frames are fed through the short-term and long-term synthesis filters to reconstruct the audio streams (step 1006); and decoded audio streams are fed to DirectX to be played back through a sound card (step 1008).

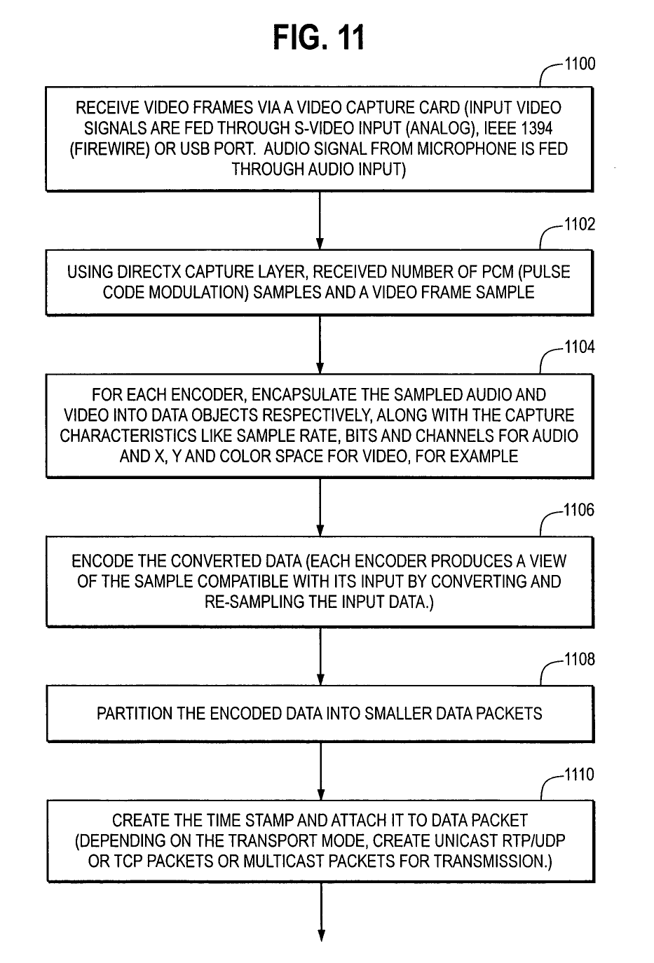

FIG. 11 illustrates a system and method for video/audio encoder data flow. The following steps are shown: receive video frames via a video capture card (input video signals are fed through S-Video input (analog), IEEE 1394 (firewire) or USB port) and receive audio signals from a microphone that are fed through an audio input (step 1100); using DirectX capture layer, receive number of Pulse Code Modulation (PCM) samples and a video frame sample (step 1102); for each encoder, encapsulate the sampled audio and video into data objects respectively, along with the capture characteristics such as sample rate, bits and channels for audio and x, y and color space for video (step 1104); encode the converted data by producing a stream of data compatible with its input by converting and re-sampling the input data (step 1106); partition the encoded data into smaller data packets (step 1108); and create the time-stamp and attach time-stamp to data packet. Depending on the transport mode, create unicast RTP/UDP or TCP packets or multicast packets for transmission (step 1110).

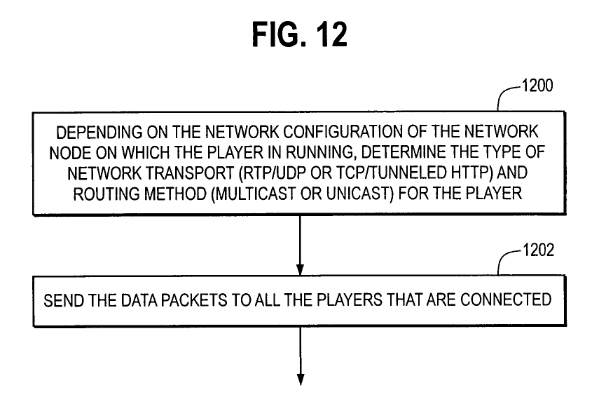

FIG. 12 illustrates a system and method for video/audio server data flow. The following steps are shown: depending on the network configuration of the network node on which the player is running, determine the type of network transport (RTP/UDP or TCP/Tunneled HTTP) and routing method (multicast or unicast) for the player (step 1200); and send the data packets to all the players that are connected to the server (step 1202).

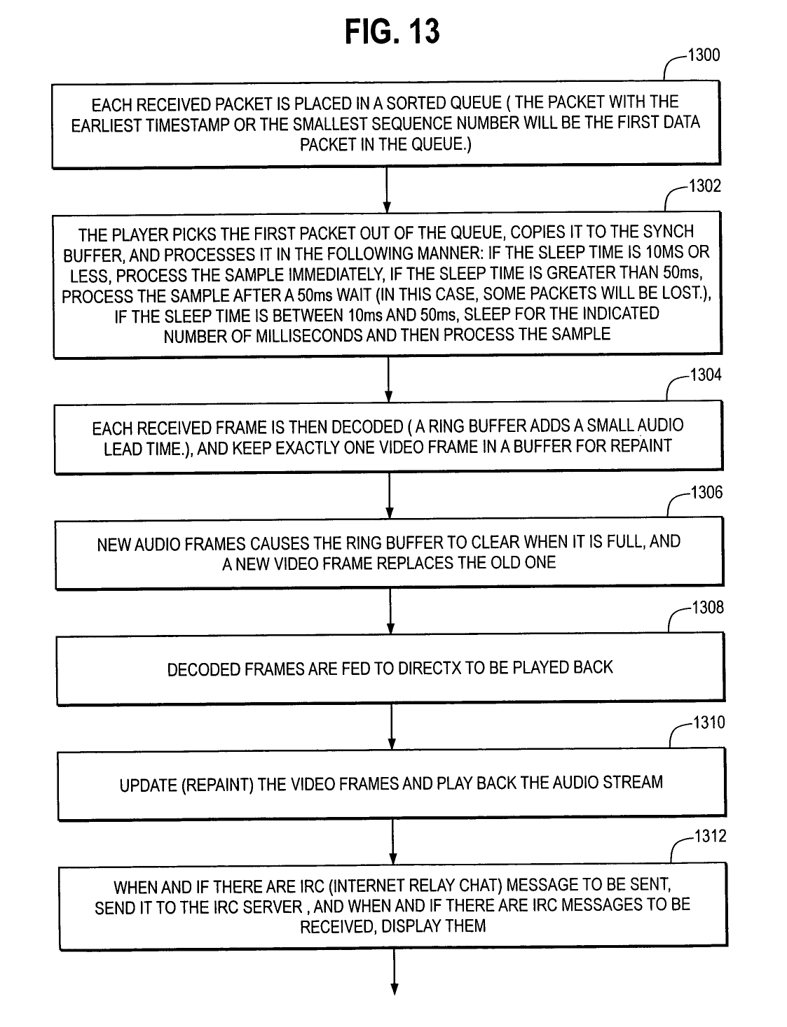

FIG. 13 illustrates a system and method for of SpeedCast Video (video/audio) player data flow. The following steps are shown: each received packet is placed in a sorted queue, the packet with the earliest time-stamp or the smallest sequence number is the first data packet in the queue (step 1300); the player picks the first packet out of the queue, copies it to a synch buffer, and processes it in the following manner: if the sleep time is 10 ms or less, process the sample immediately, if the sleep time is greater than 50 ms, process the sample after a 50 ms wait, if the sleep time is between 10 ms and 50 ms, sleep for the indicated number of milliseconds and then process the sample (step 1302); each received frame is then decoded, and keep exactly one video frame in a buffer for a repaint (step 1304); new audio frame causes the ring buffer to clear when it is full, and a new video frame replaces the old one (step 1306); decoded frames are fed to DirectX to be played back (step 1308); update (repaint) the video frames and play back the audio stream (step 1310), and when and if there are IRC messages to be sent, send them to the IRC server, and when and if there are IRC messages received, display them.

The present systems' apparatus overcomes the drawbacks of prior art systems and allow thousands of people to listen to an audio stream simultaneously and economically with very little delay. The typical latency in the audio system is about 500 ms within the pubic internet. No special hardware or media players are required. Any internet ready Windows computer with standard sound card and speaker allows users to listen to the broadcasted audio stream.

For multimedia (audio and video) systems, apparatus and methods, the system operates at under one second latency end-to-end, over the standard internet. Within a LAN, typical delay may be less than about 500 ms.

It is to be understood, of course, that the present invention in various embodiments can be implemented in hardware, software, or in combinations thereof. In the present disclosure, the words “a” or “an” are to be taken to include both the singular and the plural. Conversely, any reference to plural items shall, where appropriate, include the singular.

All patents referred to herein, are hereby incorporated herein by reference, whether or not specifically done so within the text of this disclosure.

The invention is not limited to the particular details of the apparatus and method depicted, and other modifications and applications are contemplated. Certain other changes may be made in the above-described apparatus and method without departing from the true spirit and scope of the invention herein involved. It is intended, therefore, that the subject matter in the above depiction shall be interpreted as illustrative, and not in a limiting sense.

What is claimed is:

1. A digital streaming system, comprising:
an encoder having an input port that receives at least one of input digital video signals and input digital audio signals and an output port that outputs an encoded digital multimedia signal, the encoded digital multimedia signal being encoded from the at least one of input digital video signals and input digital audio signals; and
a player having an input port that receives the encoded digital signal and an output port that outputs at least one of output digital video signals and output digital audio signals, the output digital video and audio signals being decoded from the encoded digital signal, a latency between the at least one of input digital video signals and input digital audio signals and at least one of output digital video signals and output digital audio signals being less than one second.

2. A digital multimedia streaming system, comprising:
an encoder having an input port that receives input digital video and audio signals and an output port that outputs an encoded digital multimedia signal, the encoded digital multimedia signal being encoded from the input digital video and audio signals; and
a player having an input port that receives the encoded digital multimedia signals and an output port that outputs output digital video and audio signals, the output digital video and audio signals being decoded from the encoded digital multimedia signal, a latency between the input digital video and audio signals and the output digital video and audio signals being less than one second.

3. The system according to claim 1, wherein the system further comprises a server having at least one input port that receives the encoded digital video and audio signals from the encoder and at least one output port that outputs the encoded digital video and audio signals to the player.

4. The system according to claim 1, wherein the encoded digital video and audio signals form media data, wherein the digital audio streaming system distributes real-time media data to computers via the internet, and wherein the latency is a delay of about 500 ms.

5. The system according to claim 1, wherein the encoded digital multimedia signals form media data, wherein the system effects bi-directional exchange of real-time media data between computers via the internet, and wherein the latency is a delay of about 500 ms.

6. The system according to claim 1, wherein recording of the multimedia presentation, with all timing data intact, in a manner that all aural, visual, textual, and other media data can be replayed accurately in a well synchronized manner.

7. The system according to claim 1, including seeking a particular time in the presentation allowing a synchronous reproduction of the recorded media.

8. The system according to claim 1, wherein the system further comprises a storage medium for storing at least one of encoded digital multimedia signals and output digital video and audio signals, whereby the stored media signals are supplied by the player after a length of time after the receiving of the encoded digital multimedia signals.

9. A method for digital multimedia video and audio streaming including video and audio, for use with an encoder, a server, and a player, comprising the steps of:
in an encoder:
receiving video frames using a DirectX layer, via a video capture card, and simultaneously receiving audio signals in PCM samples via an audio input;
for each encoder, converting the sampled audio and video signals into data objects respectively, along with the capture characteristics consisting of at least one of sample rate, bits and channels for audio and x, y and color space for video;
encoding the converted data into encoded data, each encoder producing a view of the sample compatible with its input by converting and re-sampling the input data;
partitioning the encoded data into smaller data packets;
creating and attaching time-stamps to respective data packets, and, as a function of a transport mode, creating at least one of unicast RTP/UDP or TCP packets or multicast packets for transmission;
in a server:
determining, as a function of a network configuration of a network node on which the player is running, determine the type of network transport (RTP/UDP or TCP/Tunneled HTTP) and routing method (multicast or unicast) for the player;
sending the data packets to all players that are connected thereto;
in a player:
placing each received packet in a sorted queue, a packet with one of an earliest time-stamp or a smallest sequence number being a first data packet in the queue;
selecting the first packet out of the queue, copying the first packet to a synch buffer, and processing the first packet as follows:
if a sleep time is less than 10 ms, processing the sample immediately;
if the sleep time is greater than 50 ms, processing the sample after a 50 ms wait;
if the sleep time is between 10 ms and 50 ms, sleeping for a predetermined number of milliseconds and then processing the sample;
decoding each received frame, adding via a ring buffer a small audio lead time, and keeping one video frame in a buffer for a repaint;
clearing, in response to a new audio frame, the ring buffer when the ring buffer is full, a new video frame replacing a previous video frame;
feeding decoded frames to DirectX to be played back;
updating the video frames, and playing back the audio stream; and
sending an outgoing IRC message, when there is an IRC message to be sent, to an IRC server, and, when there are incoming IRC messages, displaying the IRC messages.

10. A digital audio streaming system, comprising:
an encoder having an input port that receives an input digital audio signal and an output port that outputs an encoded digital audio signal, the encoded digital audio signal being encoded from the input digital signal; and
a player having an input port that receives the encoded digital audio signal and an output port that outputs an output digital audio signal, the output digital signal being decoded from the encoded digital audio signal, a latency between the input digital audio signal and the output digital audio signal being less than one second.

11. The system according to claim 10, wherein the system further comprises a server having at least one input port that receives the encoded digital audio signal from the encoder and at least one output port that outputs the encoded digital audio signal to the player.

12. The system according to claim 10, wherein the encoded digital audio signals form audio data, wherein the digital audio streaming system distributes real-time audio data to computers via the internet, and wherein the latency is a delay of about 500 ms.

13. The system according to claim 10, wherein the encoded digital audio signals form audio data, wherein the digital audio streaming system effects bi-directional exchange of real-time audio data between computers via the internet, and wherein the latency is a delay of about 500 ms.

14. The system according to claim 10, wherein the system further comprises a conversion module for capturing and encoding continuous real-time audio from a telephone system and forming the input digital signal therefrom.

15. The system according to claim 14, wherein the encoded digital audio signals form audio data, wherein the digital audio streaming system effects bi-directional exchange of real-time audio data between computers via the internet, and wherein the latency is a delay of about 500 ms.

16. The system according to claim 10, wherein the system further comprises a storage medium for storing encoded digital audio signals, whereby the stored audio signals are supplied to the player after a length of time after receipt of the encoded digital audio signals.

17. A digital audio streaming system, comprising:
an encoder having an input port that receives an input digital audio signal and an output port that outputs an encoded digital audio signal, the encoded digital audio signal being encoded from the input digital signal; and
a player having an input port that receives the encoded digital audio signal and an output port that outputs an output digital audio signal, the output digital signal being decoded from the encoded digital audio signal.

18. The system according to claim 17, wherein the system further comprises a server having at least one input port that receives the encoded digital audio signal from the encoder and at least one output port that outputs the encoded digital audio signal to the player.

19. The system according to claim 17, wherein the encoded digital audio signals form audio data, wherein the digital audio streaming system distributes real-time audio data to computers via the internet, and wherein the latency is a delay of about 500 ms.

20. The system according to claim 17, wherein the encoded digital audio signals form audio data, wherein the digital audio streaming system effects bi-directional exchange of real-time audio data between computers via the internet, and wherein the latency is a delay of about 500 ms.

21. The system according to claim 17, wherein the system further comprises a conversion module for capturing and encoding continuous real-time audio from a telephone system and forming the input digital signal therefrom.

22. The system according to claim 21, wherein the encoded digital audio signals form audio data, wherein the digital audio streaming system effects bi-directional exchange of real-time audio data between computers via the internet, and wherein the latency is a delay of about 500 ms.

23. The system according to claim 17, wherein the system further comprises a storage medium for storing encoded digital audio signals, whereby the stored audio signals are supplied by the player after a length of time after receipt of the encoded digital audio signals.

24. A digital audio streaming system, comprising:
an encoder having an input port that receives an input digital audio signal and an output port that outputs an encoded digital audio signal, the encoded digital audio signal being encoded from the input digital signal;
a server having at least one input port, which receives the encoded digital audio signal, operatively connected to the output port of the encoder from the encoder and at least one output port that outputs the encoded digital audio signal; and
a player having an input port, which receives the encoded digital audio signal, operatively connected to the output port of the server, and an output port that outputs an output digital audio signal, the output digital signal being decoded from the encoded digital audio signal, the latency between the input digital audio signal and the output digital audio signal being less than one second.

25. The system according to claim 24, wherein the system further comprises a server having at least one input port that receives the encoded digital audio signal from the encoder and at least one output port that outputs the encoded digital audio signal to the player.

26. The system according to claim 24, wherein the encoded digital audio signals form audio data, wherein the digital audio streaming system distributes real-time audio data to computers via the internet, and wherein the latency is a delay of about 500 ms.

27. The system according to claim 24, wherein the encoded digital audio signals form audio data, wherein the digital audio streaming system effects bi-directional exchange of real-time audio data between computers via the internet, and wherein the latency is a delay of about 500 ms.

28. The system according to claim 24, wherein the system further comprises a conversion module for capturing and encoding continuous real-time audio from a telephone system and forming the input digital signal therefrom.

29. The system according to claim 28, wherein the encoded digital audio signals form audio data, wherein the digital audio streaming system effects bi-directional exchange of real-time audio data between computers via the internet, and wherein the latency is a delay of about 500 ms.

30. The system according to claim 28, wherein the system further comprises a storage medium for storing at least one of encoded digital audio signals an output digital audio signals, whereby the stored audio signals are supplied by the player after a length of time after the receiving of the encoded digital audio signals.

31. A digital audio streaming system, comprising:
an encoder having an input port that receives an input digital audio signal and an output port that outputs an encoded digital audio signal, the encoded digital audio signal being encoded from the input digital signal, the encoder having a first latency;
a server having at least one input port, which receives the encoded digital audio signal, operatively connected to the output port of the encoder from the encoder and at least one output port that outputs the encoded digital audio signal, the server having a second latency;
at least one player having an input port, which receives the encoded digital audio signal, operatively connected to the output port of the server, and an output port that outputs an output digital audio signal, the output digital signal being decoded from the encoded digital audio signal, the player having a third latency; and
a system latency between a sum of the first, second, and third latencies, the system latency being less than one second.

32. The system according to claim 31, wherein the system further comprises a server having at least one input port that receives the encoded digital audio signal from the encoder and at least one output port that outputs the encoded digital audio signal to the player.

33. The system according to claim 31, wherein the encoded digital audio signals form audio data, wherein the digital audio streaming system distributes real-time audio data to computers via the internet, and wherein the latency is a delay of about 500 ms.

34. The system according to claim 31, wherein the encoded digital audio signals form audio data, wherein the digital audio streaming system effects bi-directional exchange of real-time audio data between computers via the internet, and wherein the latency is a delay of about 500 ms.

35. The system according to claim 31, wherein the system further comprises a conversion module for capturing and encoding continuous real-time audio from a telephone system and forming the input digital signal therefrom.

36. The system according to claim 35, wherein the encoded digital audio signals form audio data, wherein the digital audio streaming system effects bi-directional exchange of real-time audio data between computers via the internet, and wherein the latency is a delay of about 500 ms.

37. The system according to claim 35, wherein the system further comprises a storage medium for storing encoded digital audio signals, whereby the stored audio signals are supplied by the player after a length of time after receipt of the encoded digital audio signals.

38. A digital audio streaming system, comprising:
an encoder having an input port that receives an input digital audio signal and an output port that outputs an encoded digital audio signal, the encoded digital audio signal being encoded from the input digital signal, the output port being operatively connected to the internet and the encoded digital signal being output to the internet in packets;
a server having at least one input port, which receives the packets from the encoder, operatively connected to the output port of the encoder via the internet, and at least one output port that outputs the encoded digital audio signal;
at least one player having an input port, which receives the encoded digital audio signal from the server, operatively connected to the output port of the server, and an output port that outputs an output digital audio signal, the output digital signal being decoded from the encoded digital audio signal; and
a system latency between the input digital audio signal received by the encoder and the output digital audio signal output by the player being less than one second.

39. The system according to claim 1, wherein the encoder has an mpeg-4 encoding module, and wherein the player has an mpeg-4 decoding module.

40. A method for digital audio streaming, comprising the steps of:
in an encoder:
waiting for the phone to ring;
picking up, when a call is made, via a modem program of the encoder, the phone;
recording 8 kHz PCM samples from speech input generated from the modem to produce audio signals;
dividing the audio signals into 20 ms long frames;
using a GSM codec to compress the 20 ms long frame into a data packet representing particular excitation sequence and amplitude by using short-term and long-term predictors; and
time-stamping the packet with a current time;
in a server:
depending on the network configuration of the network node the player resides in, determining the type of network transport (RTP/UDP or TCP/Tunneled HTTP) and routing method (multicast or unicast) for the player; and
sending the data packets to all the players that are connected to the server;
in a player:
placing each received packet in a sorted queue, a packet with one of an earliest time-stamp or a smallest sequence number being a first data packet in the queue;
selecting the first packet out of the queue, coping the first packet to a synch buffer, and processing the first packet as follows:
if a sleep time is less than 10 ms, processing the sample immediately;
if the sleep time is greater than 50 ms, processing the sample after a 50 ms wait;
if the sleep time is between 10 ms and 50 ms, sleeping for a predetermined number of milliseconds and then processing the sample;
decoding each received frame, a ring buffer adding a small audio lead-time;
clearing, in response to a new audio frame, the ring buffer when the ring buffer is full;
feeding excitation signals in the frames through short-term and long-term synthesis filters to reconstruct the audio streams; and
feeding the decoded audio streams to DirectX to be played back through a sound card.
